(19) United States
(12) Patent Application Publication
(10) Pub. No.: US 2006/0283325 A1
(43) Pub. Date: Dec. 21, 2006

(54) Oxygen concentrating apparatus and rotary valve

(76) Inventor: Masato Sugano, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/568,886

(22) PCT Filed: Sep. 9, 2004
(86) PCT No.: PCT/JP04/13494

§ 371 Date: Feb. 21, 2006

(30) Foreign Application Priority Data
Sep. 9, 2003 (JP) 2003-316702
Sep. 10, 2003 (JP) 2003-318005

(51) Int. Cl. B01D 53/02

(52) U.S. Cl. 96/121

(57) ABSTRACT

According the present invention, an oxygen enriched gas is generated by adsorbing and removing nitrogen gas from air with an oxygen concentrating apparatus which conducts the steps of (1) pressurizing one of the adsorption cylinders by directing the compressed air; (2) removing the oxygen enriched gas from said one of the adsorption cylinders to the output conduit; (3) reducing the pressure in said one of the adsorption cylinders by directing the oxygen enriched gas into one of the other adsorption cylinders to increase the pressure in the one of the other adsorption cylinders; (4) evacuating the internal gas out of said one of the adsorption cylinders; and (5) increasing the pressure in said one of the adsorption cylinders by directing the oxygen enriched gas into said one of the adsorption cylinders from one of the other adsorption cylinders in which the pressure is decreased in step (3).

### BACKGROUND OF THE INVENTION

1. Field of the Invention

The present invention relates to an oxygen concentrating apparatus and a rotary valve.

2. Description of the Related Art

FIG. 29 is a schematic illustration of a pressure swing type gas oxygen concentrating apparatus 300 which includes two adsorption cylinders 302a and 302b,an air compressor 304 for supplying compressed air to the adsorption cylinders 302a and 302b through conduit 308, four-way directional control valve 306, conduits 310a and 310b, an O₂ tank 320 to which the oxygen enriched gas is supplied from the adsorption cylinders 302a and 302b through output conduits 312a and 312b and shut off valves 318. The oxygen enriched gas is supplied from the O₂ tank to a user through a conduit 322 and a flow control valve 324. Provided between the output conduits 312a and 312b are a orifice 314 and a pressure equalizing valve 316.

According to the oxygen concentrating apparatus 300, it is difficult to control each of the steps of the oxygen concentrating process, which are disclosed in, for example U.S. Pat. No. 2,944,627, U.S. Pat. No. 3,237,377 and Japanese Unexamined Patent Publication (Kokai) No. 10-151315, and to increase the efficiency of the apparatus because four-way directional control valve 306 is used.

JPP '315 also describes an oxygen concentrating apparatus including a rotary valve, instead of the four-way directional valve, for switching the flow direction and controlling the steps of the oxygen concentrating process. However, the conventional rotary valve has a problem that there is unbalance in the pressure applied to the interface between the rotor and the stator of the rotary valve.

### SUMMARY OF THE INVENTION

The invention is directed to solve the above mentioned prior art problems, an the objective of the invention is to provide an oxygen concentrating apparatus which solves the above-described problems of the prior art.

According to the present invention, there is provided with an oxygen concentrating apparatus, for generating an oxygen enriched gas by adsorbing and removing nitrogen gas from air, comprising: a plurality of adsorption cylinders which is filled with holding an adsorbent which selectively adsorbs nitrogen gas more than oxygen gas, the adsorption cylinders having first and second orifices; a output conduit for directing the oxygen enriched gas to a user through the first orifice; means for supplying compressed air to the adsorption cylinders through the second orifice; means for evacuating nitrogen gas from the adsorption cylinders through the second orifice; and valve means for allowing the oxygen concentrating apparatus sequentially in each of the adsorption cylinders:

(1) to pressurize one of the adsorption cylinders by directing the compressed air through the second orifice thereof;

(2) to remove the oxygen enriched gas from said one of the adsorption cylinders to the output conduit through the first orifice thereof,

(3) to direct the oxygen enriched gas as a purge gas from said one of the adsorption cylinders through the first orifice thereof into one of the other adsorption cylinders through the first orifice thereof, from which one of the other adsorption cylinders the internal gas is evacuated; and

(4) to evacuate the internal gas out of said one of the adsorption cylinders through the second thereof.

Further, according to another feature of the present invention, there is provided an oxygen concentrating apparatus, for generating an oxygen enriched gas by adsorbing and removing nitrogen gas from air, comprising: a plurality of adsorption cylinders for holding an adsorbent which selectively adsorbs nitrogen gas more than oxygen gas, the adsorption cylinders having first and second orifices; a output conduit for directing the oxygen enriched gas to a user through the first orifice; means for supplying compressed air to the adsorption cylinders through the second orifice; means for evacuating nitrogen gas from the adsorption cylinders through the second orifice; and valve means for allowing the oxygen concentrating apparatus, sequentially in each of the adsorption cylinders:

(1) to pressurize one of the adsorption cylinders by directing the compressed air through the second orifice thereof;

(2) to remove the oxygen enriched gas from said one of the adsorption cylinders to the output conduit through the first orifice thereof,

(3) to reduce the pressure in said one of the adsorption cylinders by directing the oxygen enriched gas through the first orifice into one of the other adsorption cylinders through the first orifice thereof to increase the pressure in the one of the other adsorption cylinders; and

(4) to evacuate the internal gas out of said one of the adsorption cylinders through the second thereof.

Further, according to another feature of the present invention, there is provided a method of generating an oxygen enriched gas by adsorbing and removing nitrogen gas from air with an oxygen concentrating apparatus having a plurality of adsorption cylinders for holding an adsorbent which selectively adsorbs nitrogen gas more than oxygen gas, a output conduit for directing the oxygen enriched gas to a user, means for supplying compressed air to the adsorption cylinders, and means for evacuating nitrogen gas from the adsorption cylinders, the method comprising the steps of:

(1) pressurizing one of the adsorption cylinders by directing the compressed air;

(2) removing the oxygen enriched gas from said one of the adsorption cylinders to the output conduit;

(3) reducing the pressure in said one of the adsorption cylinders by directing the oxygen enriched gas into one of the other adsorption cylinders to increase the pressure in the one of the other adsorption cylinders;

(4) evacuating the internal gas out of said one of the adsorption cylinders; and

(5) increasing the pressure in said one of the adsorption cylinders by directing the oxygen enriched gas into said one of the adsorption cylinders from one of the other adsorption cylinders in which the pressure is decreased in step (3).

Further, according to another feature of the present invention, there is provided a rotary valve, adapted to use in a flow system including a plurality of common flow passages and a selective flow passage group composed of a plurality of subgroups, each of the subgroups including the same number M of flow passages, for switching the fluid communications between at least one of the plurality of common flow passages and at least one of the flow passages of the selective flow passage group and/or between the flow passages of the subgroups, the rotary valve comprising: a stator comprising a plate member including opposing front and rear sides, a plurality of ports which extend between the front and rear sides through the plate member and fluidly communicate with the common flow passages and the flow passages of the plurality of subgroups of the selective flow passage group; a rotor rotatable about an axis relative to the stator, the rotor comprising a plate member including a front side contacting with the front side of the stator and an opposite rear side, the plate member of the rotor defining in its front side a plurality of openings each of which can fluidly communicate with each of the ports of the rotor, the plurality of openings of the stator being disposed symmetrically about the axis so that the configuration of the front side coincides with the configuration of the front side of the rotor when the rotor rotates by 1/n rotations (n: integer); the ports of the stator, which fluidly communicate with the flow passages of the different subgroups of the selective flow passage group, being disposed along circles of different diameter about the axis; each of the ports, fluidly communicating with the flow passages of one of the subgroups, is disposed at any one of (i)th point, (m+i)th point, (2m+i)th point, (3m+i)th point, . . . , ((n−1)m+i)th point (i: integer=1 to m) along the circle; and the points which equally divide the circle into a plurality of (nm) segments.

### DESCRIPTION OF THE DRAWINGS

These and other objects and advantages and further description will now be discussed in connection with the drawings in which:

FIG. 1 is a schematic illustration of an oxygen concentrating apparatus according to a first embodiment of the present invention;

FIG. 2 is partial section of a concentrator according to the first embodiment of the present invention;

FIG. 3 an exploded perspective view of a rotary valve with a lower header of the concentrator of FIG. 2;

FIG. 4 is a plan view of the lower header;

FIG. 5 is plan view of a stator of the rotary valve attached to the lower header;

FIG. 6 is a plan view similar to FIG. 4 with the lower header shown by broken lines;

FIG. 7 is a plan view of a front side of a stator of the rotary valve;

FIG. 8 is a plan view of a rear side of a stator of the rotary valve;

FIG. 9 is a plan view similar to FIG. 7 with the stator shown by broken lines;

FIG. 10 a section of the assembly of the stator and rotor along line X-X in FIG. 9;

FIG. 11 a section of the assembly of the stator and rotor along line XI-XI in FIG. 9;

FIG. 12 is a plan view of the front side of the rotor with the stator shown by solid lines for explaining the operation of the oxygen concentrator according to the first embodiment;

FIG. 13 is a plan view similar to FIG. 12 showing the front side of the rotor which rotates 15 degrees, relative to the stator, from the position shown in FIG. 12 in the rotational direction R;

FIG. 14 is a chart showing the cycle of the process conducted by the oxygen concentrator according to the first embodiment;

FIG. 15 is a chart showing the cycle of the process conducted by the oxygen concentrator according to the first embodiment;

FIG. 16 is a partial section of a concentrator according to a second embodiment of the present invention;

FIG. 17 is a plan view of a rotary valve with a lower header of the concentrator of FIG. 16;

FIG. 18 is a plan view of a stator of the rotary valve;

FIG. 19 is a plan view the lower header;

FIG. 20 is a plan view similar to FIG. 19 with adsorption cylinders shown by broken lines;

FIG. 21 is a plan view of a rear side of a rotor of the rotary valve;

FIG. 22 is a plan view of a front side of a rotor of the rotary valve;

FIG. 23 is a section of the rotor along line A-A in FIG. 22;

FIG. 24 is a section of the assembly of the lower header, the stator and the rotor along line IIXIV-IIXIV in FIG. 17;

FIG. 25 is a section of the assembly of the lower header, the stator and the rotor along line IIXV-IIXV in FIG. 17;

FIG. 26 is a chart showing the cycle of the process conducted by the oxygen concentrator according to the second embodiment;

FIG. 27 is a plan view of the front side of the rotor with the stator shown by solid lines for explaining the operation of the oxygen concentrator according to the second embodiment;

FIG. 28 is a plan view similar to FIG. 12 showing the front side of the rotor which rotates 15 degrees, relative to the stator, from the position shown in FIG. 12 in the rotational direction R; and

FIG. 29 is a schematic illustration of an oxygen concentrating apparatus of a prior art.

### DESCRIPTION OF THE PREFERRED EMBODIMENTS

With reference to the drawings, preferred embodiments of the present will be described below.

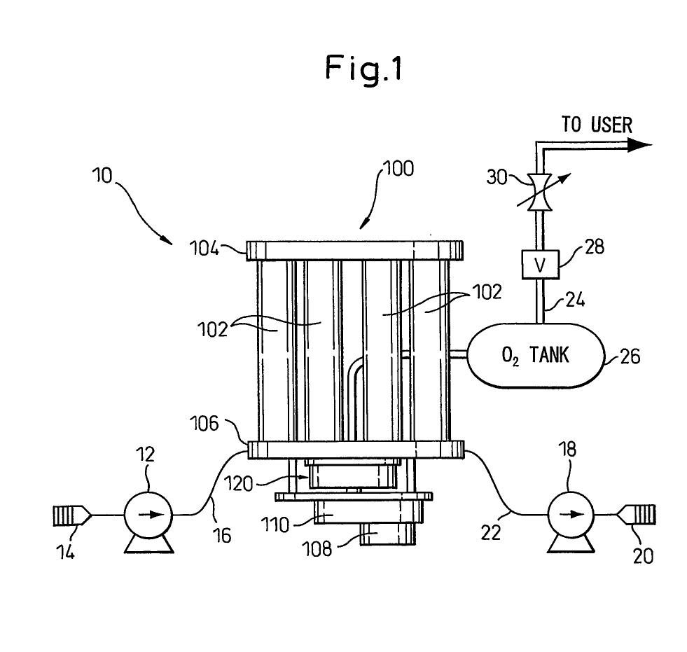

In FIG. 1, an oxygen concentrating apparatus according to a first embodiment of the present invention is shown. The oxygen concentrating apparatus 10 has an oxygen concentrator 100 which generates an oxygen enriched gas by adsorbing and separating nitrogen gas from the air, an air supplying means, comprising a compressor 12 and a filter 14, for supplying compressed air to the oxygen concentrator 100 through an air supply conduit 16, an exhausting means, comprising a vacuum pump 18 and a muffler 20, for drawing nitrogen gas through exhaust conduit 22, a reservoir or an O₂ tank 26, a pressure regulating valve 28, a flow control valve 30 which are disposed along an oxygen supply conduit 24 for directing the oxygen enriched gas to a user.

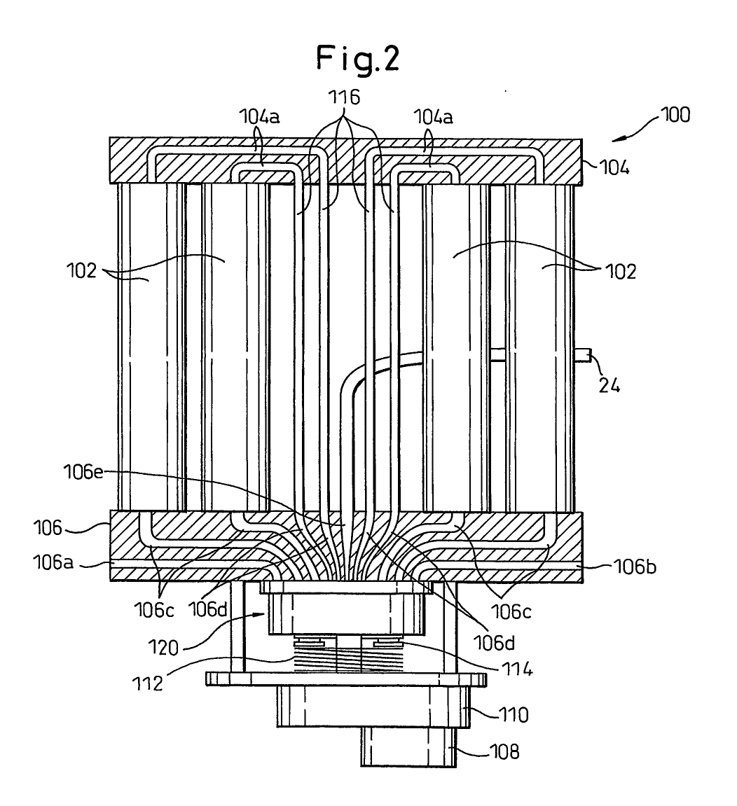

With reference to FIG. 2, the oxygen concentrator 100 includes a plurality of adsorption cylinders 102 which are arranged parallel to each other and filled with an adsorbent, for example, zeolite for selectively adsorbing nitrogen gas more than oxygen gas, upper and lower headers 104 and 106 holding the plurality of adsorption cylinders 102 therebetween, a rotary valve 120 and drive mechanism, comprising a motor 108 and a gear box 110, for rotating the rotary valve 120 about an axis parallel to the adsorption cylinders 102, a spring 112 for biasing a cover of the rotary valve 120, as described below, and a bearing 114 which allows the rotary valve to rotate 120.

The oxygen concentrator 100 according to the first embodiment has four adsorption cylinders 102 each of which includes a top or first orifice (not shown) and a bottom or second orifice (not shown). The upper header 104 includes six passages 104a which are fluidly connected to the upper orifices of the adsorption cylinders 102. The lower header 106 includes a supply passage 106a which is fluidly connected to the compressor 12 through the air supply conduit 16, an exhaust passage 106b which is fluidly connected to the vacuum pump 18 through the exhaust conduit 22, first passages 106c which are fluidly connected to the bottom orifices of the adsorption cylinders 102 and second passages 106d which are fluidly connected to the passages 104a of the upper header 104 through connection conduits 116.

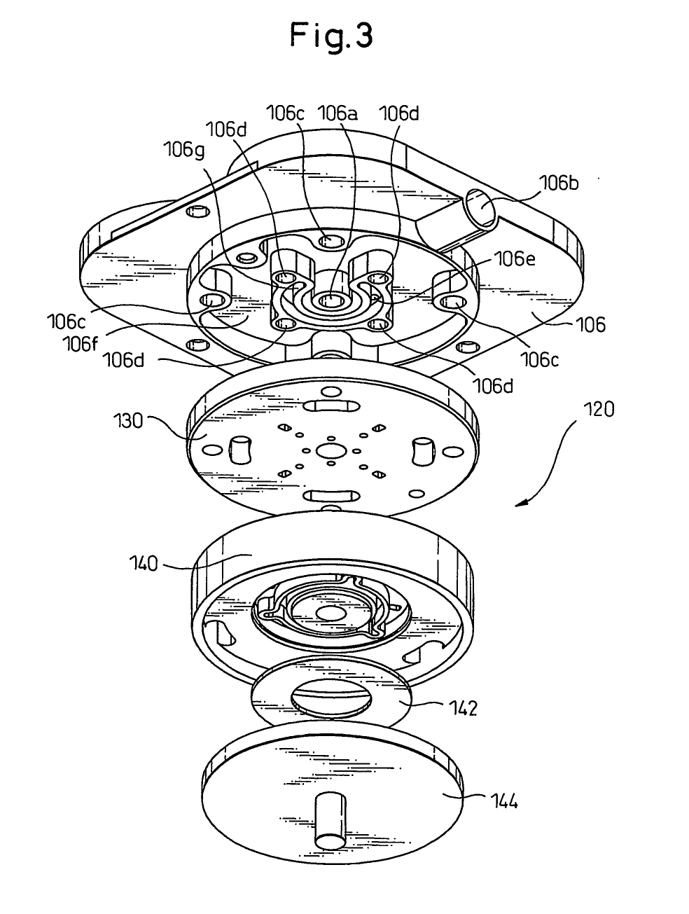

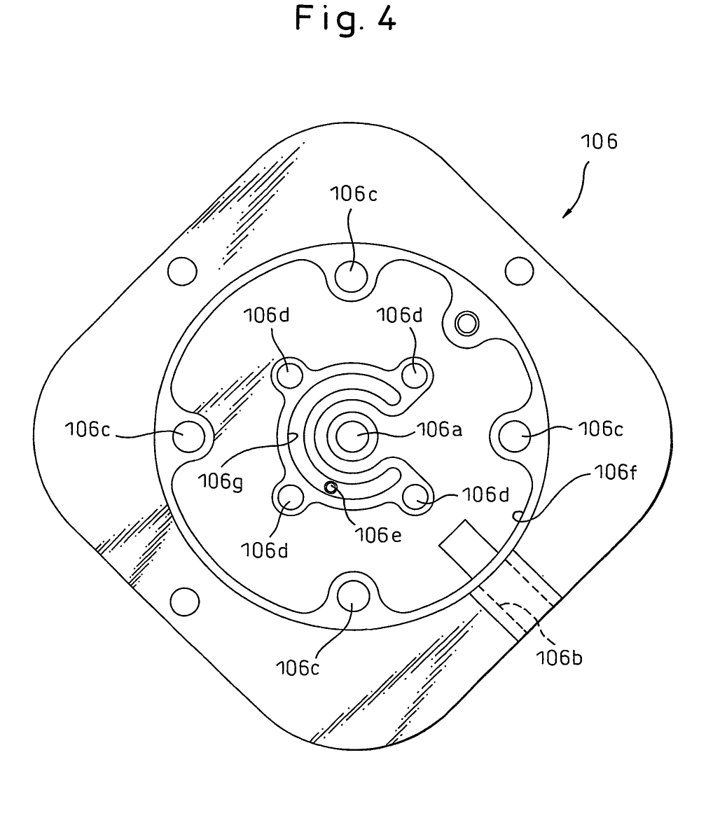

With reference to FIGS. 3 and 4, the lower header 106 further includes a C-shaped output groove 106g extending around the centrally disposed supply passage 106a, a output passage 106e which opens to the output groove 106g and is fluidly connected to the oxygen supply conduit 24 and an exhaust groove 106f around the output groove 106g which fluidly communicates with the exhaust passage 106b.

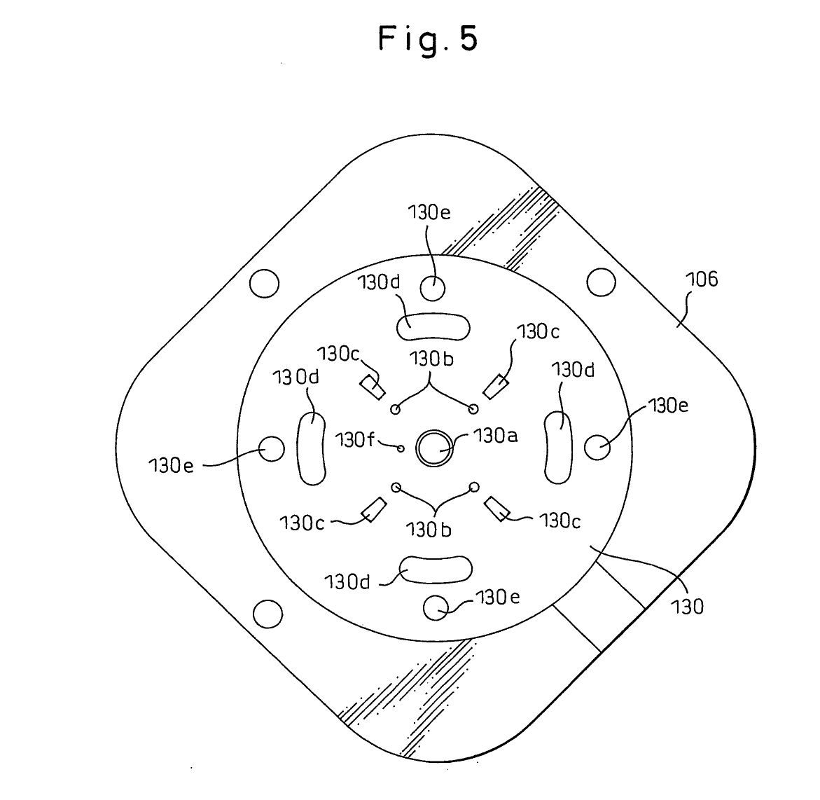

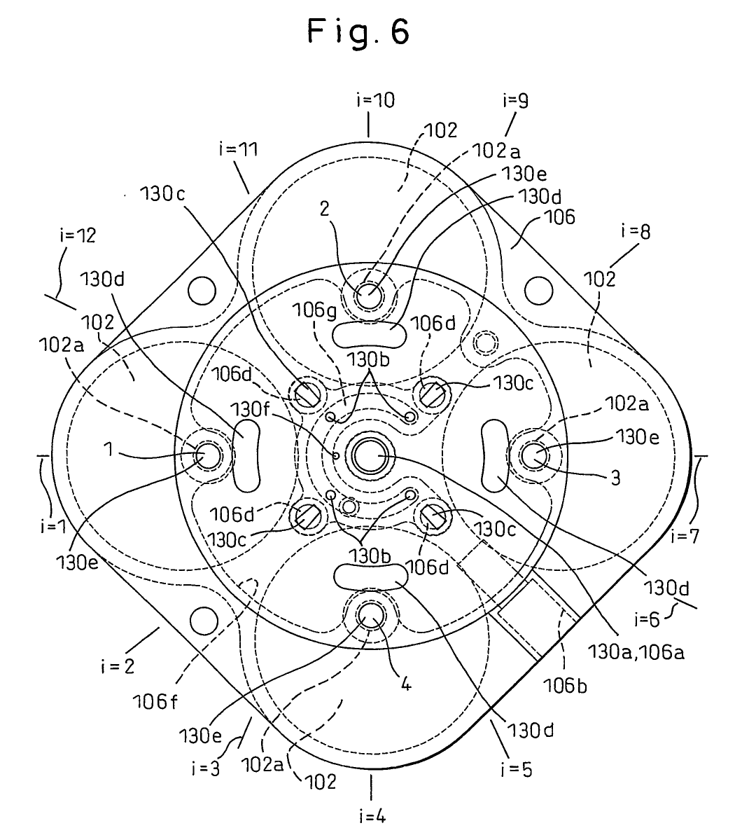

In FIG. 3, the rotary valve 120 includes a stator 130 comprising a circular plate member, stationarily attached to the lower header 106, and a rotor 140 comprising a circular plate member which is rotated by the motor 108 relative to the stator 130. With reference to FIGS. 5 and 6, the stator 130 includes a centrally disposed supply port 130a, four output ports 130b, four first ports 130c, four exhaust ports 130d, four second ports 130e and a sealing port 130f which extend through the plate member of the stator 130. The supply port 130a fluidly communicates with the supply passage 106a of the header 106. The output ports 130b fluidly communicate with the output passage 106e through the output groove 106g. The first ports 130c fluidly communicate with the second passages 106d of the lower header 106. The exhaust ports 130d fluidly communicate with the exhaust passage 106b through the exhaust groove 106f. The second ports 130e fluidly communicate with the first passages 106c of the lower header 106. The sealing port 130f fluidly communicates with the exhaust passage 106b through the exhaust groove 106f.

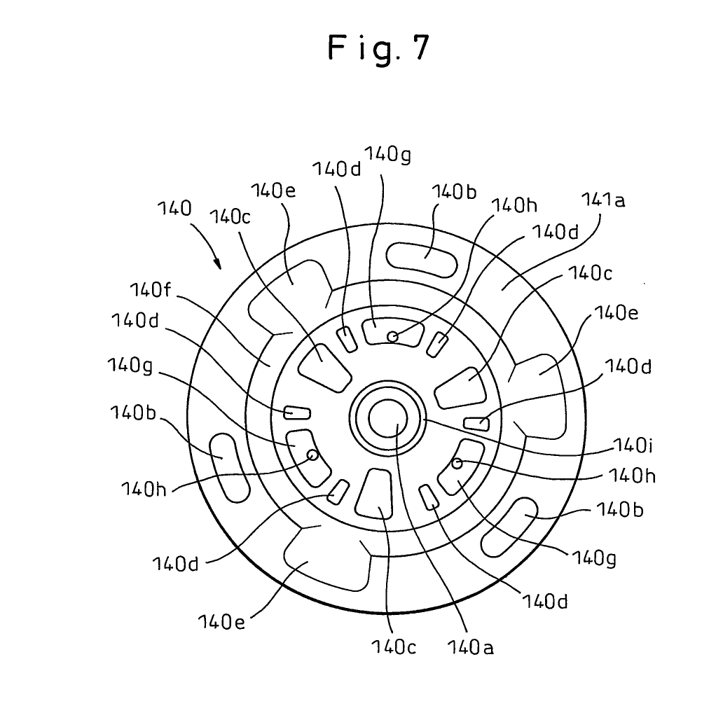

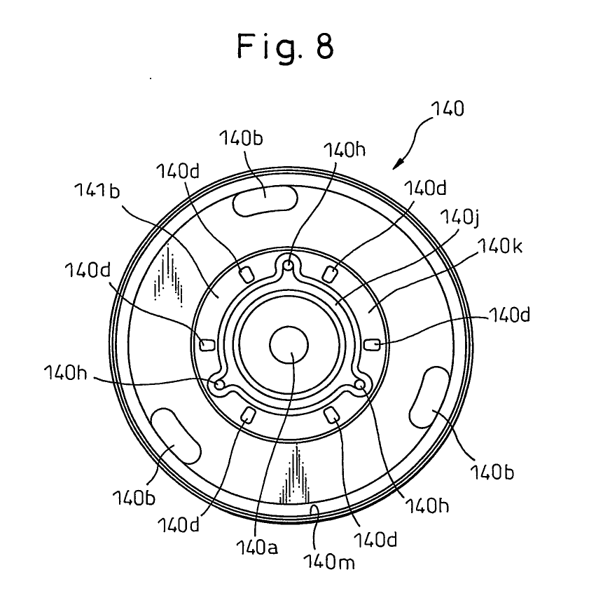

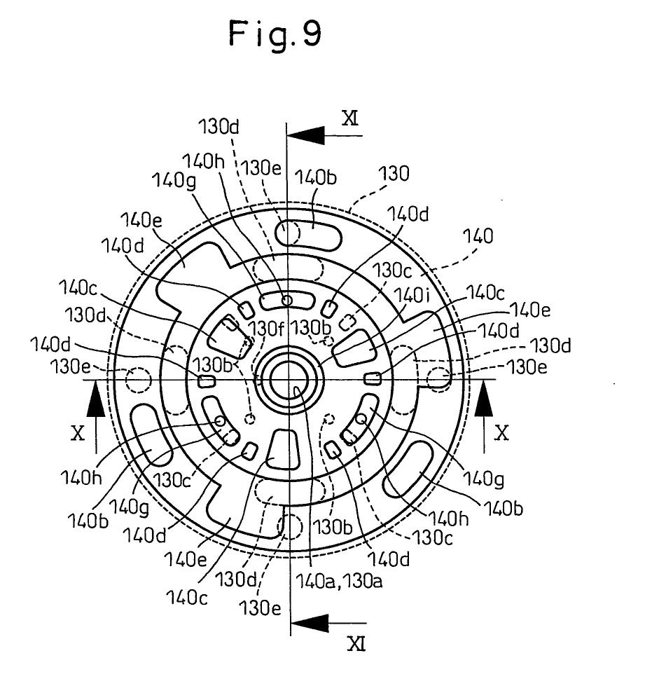

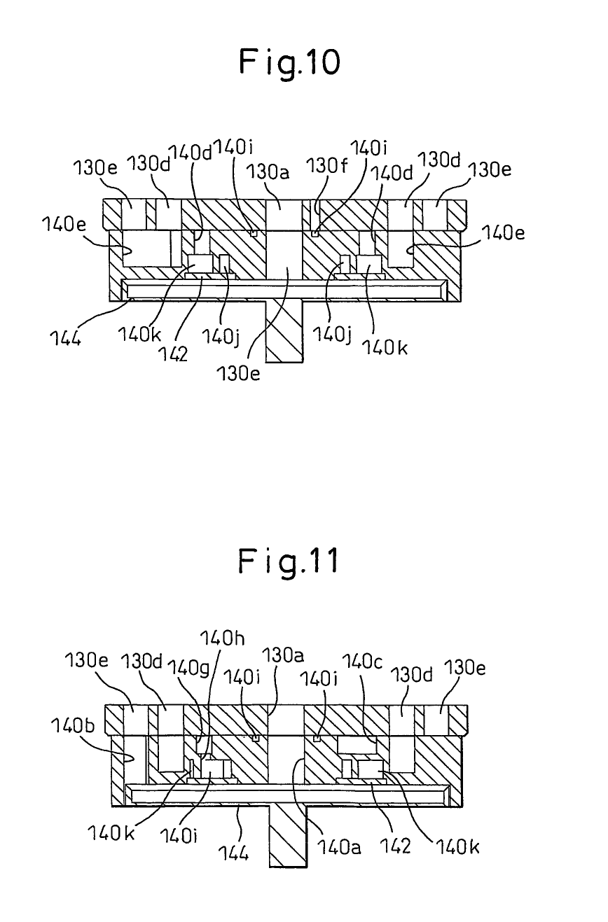

With reference to FIGS. 7-11, the rotor 140 has a front face 141a contacting the stator 130 and an opposite rear face 141b. On the front face 141a, the rotor 140 defines three first recesses 140c, three second recesses 140e which are fluidly connected to each other by a circular groove 140f, three third recesses 140g and a circular sealing recess 140i. The circular groove 140f is disposed to fluidly communicate with the exhaust ports 130d of the stator 130. On the rear face 141b, the rotor 140 defines a receptacle 140m for receiving a cover 144, an inner groove 140j and a outer groove 140k. A flow passage 143 is defined between the cover 144 disposed in the receptacle 140m and the rotor 140. The rotor 140 further includes a centrally disposed supply opening 140a, three first openings 140b, six second openings 140d and three third openings 140h which axially extend through the rotor 140. The third openings 140h fluidly connect the third recesses 140g to the inner groove 140j.

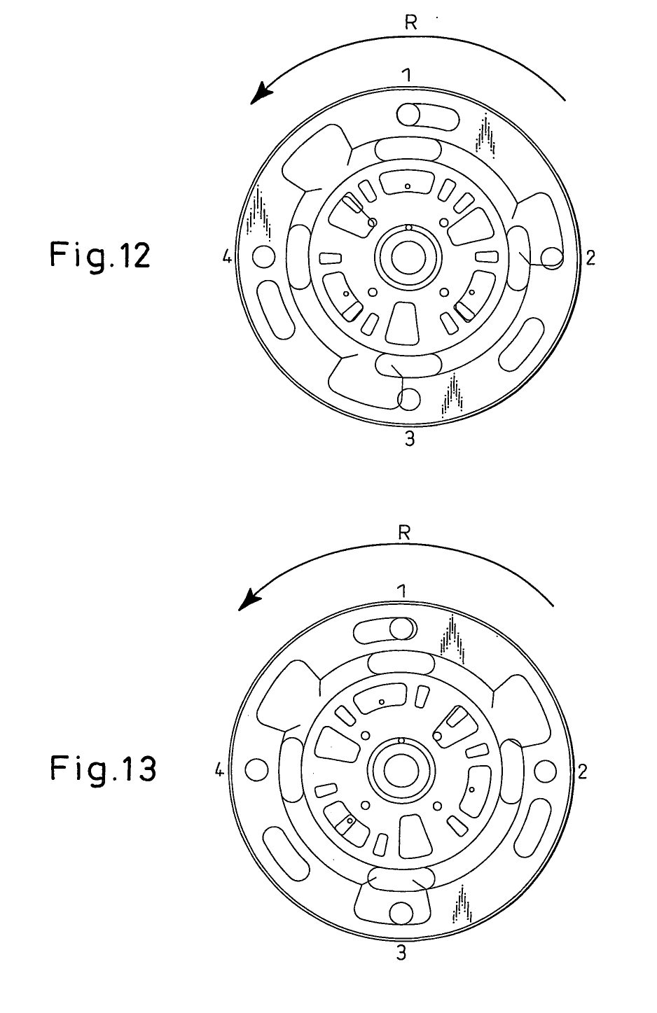

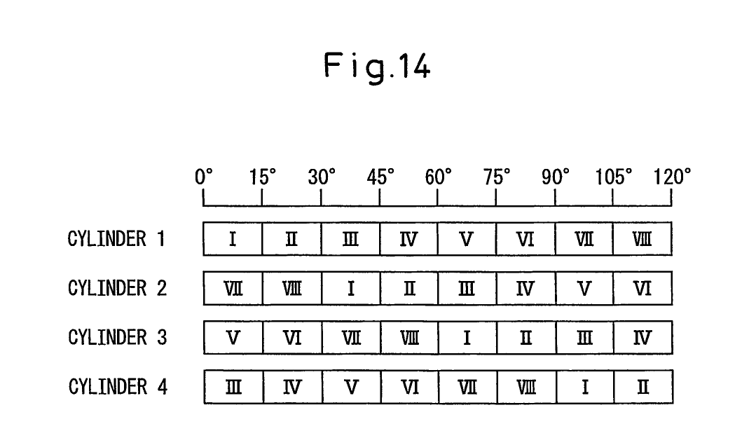

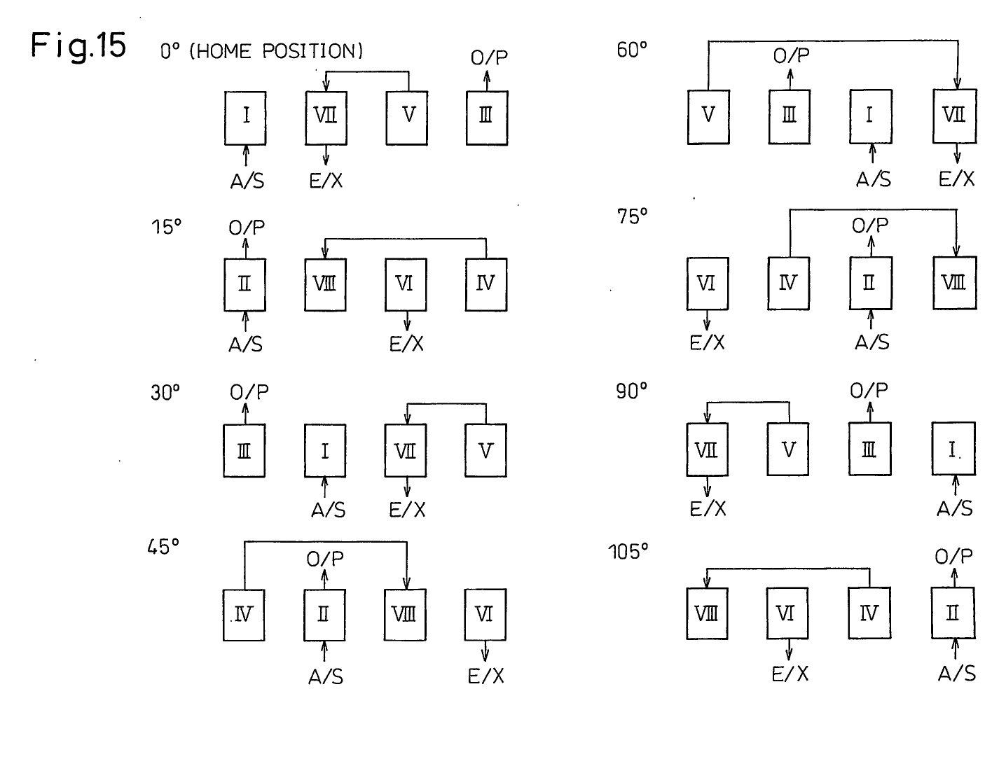

With reference to FIGS. 12-15, the operation of the oxygen concentrator 100 according the first embodiment will be described below. In the first embodiment, the oxygen concentrator 100 includes four adsorption cylinders 102 the positions of which are indicated by reference numbers 1-4, in FIGS. 12 and 13. In the following description, the operation of the oxygen concentrator 100 will be described in relation to one of the adsorption cylinders, cylinder 1 which is disposed at position 1.

Step I (Pressurization Step)

The rotor 140 is at the home position shown in FIG. 12 where one of the first openings 140b aligns with one of the second ports 130e of the stator 130 so that the air is supplied to cylinder 1 from the compressor 12 through the air supply conduit 16, the supply passage 106a of the lower header 106, the supply port 130a of the stator 130a, the supply opening 140a of the rotor 140, the passage 143 defined between the stator 140 and the cover 144, the first opening 140b of the rotor 140, the second port 130e of the stator 130 and the lower orifice of cylinder 1.

Step II (Pressurization-Generation Step)

The rotator 140 rotates in the direction R to a rotational position at 15 degrees from the home position where the first opening 140b is still aligned with the second port 130e and the compressed air is supplied to cylinder 1, as described above. At the same time, the first recess 140c of the rotor 140 aligns with the output port 130b and the first port 130c of the stator 130. This rotational position of the rotor 140 allows the oxygen enriched gas to flow from cylinder 1 to the user through the upper orifice of cylinder 1, the passage 104a of the upper header 104, the connection conduit 116, second passage 106d of the lower header 106, the first ports 130c of the stator 130, the first recess 140c of the rotor 140, the output port 130b of the stator 130, the output groove 106g, the output passage 106e of the lower header 106 and the output conduit 24.

Step III (Generation Step)

The rotator 140 rotates to a rotational position at 30 degrees from the home position where the first opening 140b of the rotor 140 is not aligned with the second port 130e of the stator 130, and therefore, the supply of the compressed to cylinder 1 is terminated. However, the first recess 140c is still aligned with both the output port 130b and the first ports 130c of the stator 130. Therefore, the oxygen enriched gas is still supplied to the user from cylinder 1 as described above.

Step IV (Depressurization-Equalization Step)

The rotor 140 rotates to a rotational position at 45 degrees from the home position where two of the six second openings 140d align with the first ports 130c communicating with cylinders 1 and 3. This rotational position of the rotor 140 allows the oxygen enriched gas to flow from cylinder 1 to cylinder 3 through the upper orifice of cylinder 1, the passage 104a of the upper header 104, the connection conduit 116, the second passage 106d of the lower header 106, the first port 130c of the stator 130, the second opening 140d, the outer groove 140k, the second opening 140d of the rotor 140, the first port 130c of the stator 130, the second passage 106d of the lower header 106, the connection conduit 116, the passage 104a of the upper header 104 and the upper orifice of cylinder 4. Thus, the pressure in cylinder 1 is reduced and the pressure in cylinder 3 is increased to equalize the pressure in cylinders 1 and 3.

Step V (Cocurrent Depressurization Step)

The rotor 140 rotates to a rotational position at 60 degrees from the home position where two of the three third recesses 140g of the stator 140 align with the first ports 130c communicating with cylinders 1 and 4. This rotational position of the rotor 140 allows the oxygen enriched gas to flow from cylinder 1 to cylinder 4, as a purge gas through the upper orifice of cylinder 1, the passage 104a of the upper header 104, the connection conduit 116, the second passages 106d of the lower header 106, the first port 130c of the stator 130, the third recess 140g, the third opening 140h, the inner groove 140j, the third opening 140h, the third recess 140g of the stator 140, the first port 130c of the stator 130, the second passages 106d of the lower header 106d, the connection conduit 116, the passage 104a of the upper header 104 and the upper orifice of cylinder 4. At the same time, a purge step, which will be described below, is conducted in cylinder 4.

Step VI (Evacuation Step)

The rotor 140 rotates to a rotational position at 75 degrees from the home position where the second recess 140e of the rotor 140 aligns with the second port 130e of the stator 130. This rotational position of the rotor 140 allows the gas in cylinder 1 to be evacuated by the vacuum pump 22 through the lower orifice of cylinder 1, the first passage 106c of the lower header 106, the second port 130e of the stator 130, the second recess 140e, the circular groove 140f of the rotor 140, the exhaust port 130d of the stator 130, the exhaust groove 106f, the exhaust passage 106b of the lower header 106 and the exhaust conduit 22.

Step VII (Purge Step)

The rotor 140 rotates to a rotational position at 90 degrees from the home position where the second port 130e of the stator 130 still aligns with the second recess 140e and two of the three third recesses 140g of the stator 140 align with the first ports 130c communicating with cylinders 1 and 2. Therefore, the oxygen enriched gas is supplied, as a purge gas, to cylinder 1 from cylinder 2 as described in relation to Step V while the gas in cylinder 1 is still evacuated as described above.

Step VIII (Pressurization-Equalization Step)

The rotor 140 rotates to a rotational position at 105 degrees from the home position where two of the six second openings 140d align with the first ports 130c communicating with cylinders 1 and 3. This rotational position of the rotor 140 allows the oxygen enriched gas to flow from cylinder 3 to cylinder 1 as described above in relation to Step IV.

As shown in the drawings, in the first embodiment, the four output ports 130b, the four first ports 130c, the four exhaust ports 130d, and the four second ports 130e are disposed along different circles about the rotational axis of the rotor 140. Further, each of the ports fluidly communicating with each of the adsorption cylinders 102 are disposed at any one of (i)th point, (m+i)th point, (2m+i)th point, (3m+i)th point, . . . , ((n−1)m+i)th point (i: integer=1 to m) along the circle. Here, i is integer i=1 to m, m is number of the adsorption cylinders and n is the number of cycle of the above described process during one rotation of the rotor, that is 3 in the first embodiment. This arrangement prevents the concentrator 100 from executing the same steps of the above described process at a rotational position of the rotor 140.

Further, according to the first embodiment of the present invention, the supply passage 106a, the exhaust passage 106b and the output passage 106e provide a common flow passages. The upper or first orifices of the adsorption cylinders 102 provide flow passages of a first subgroup of a selective flow passage group and the lower or second orifices 102a of the adsorptions cylinders 102 provide flow passages of a second subgroup of the selective flow passage group.

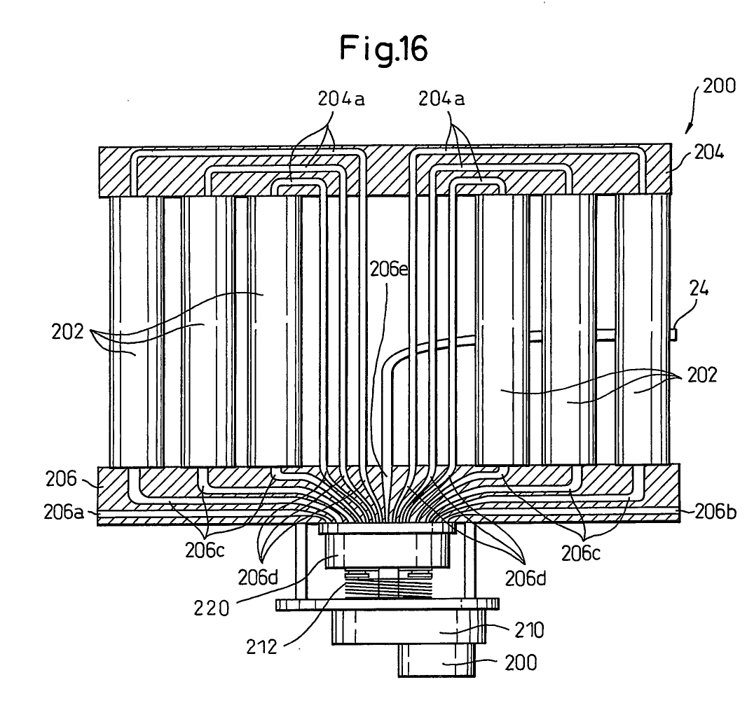

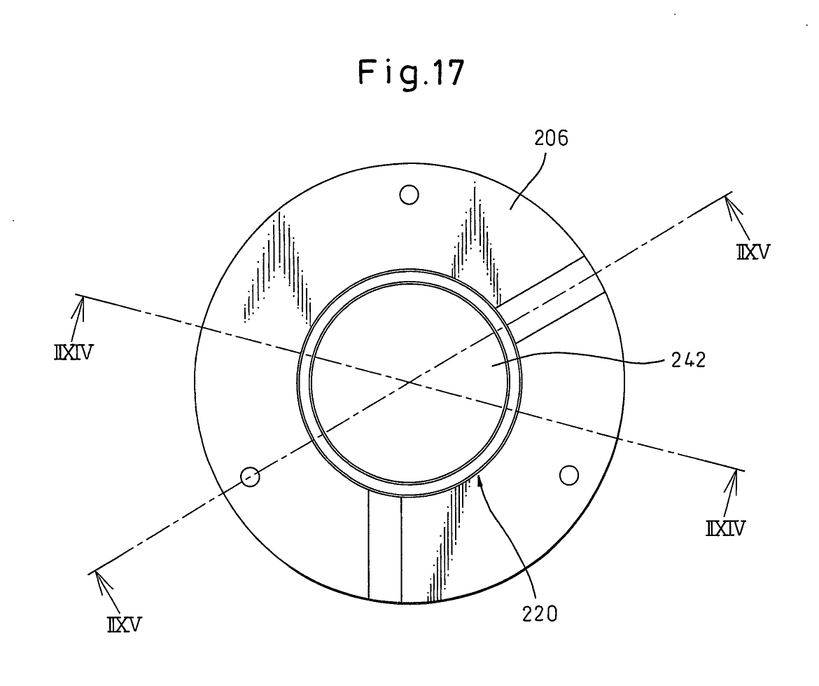

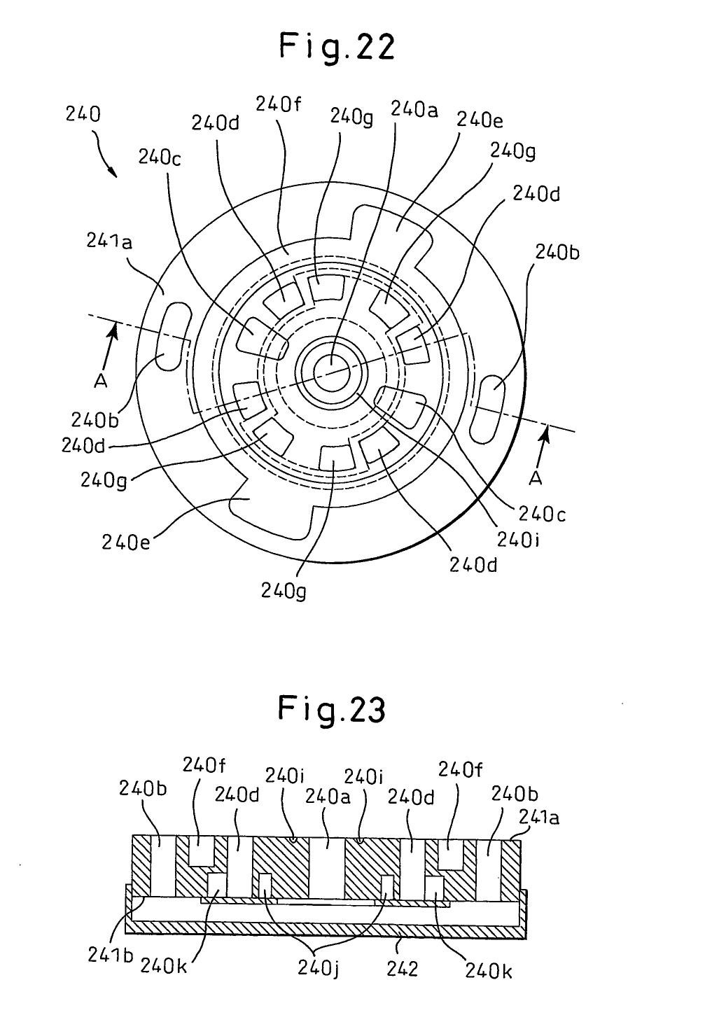

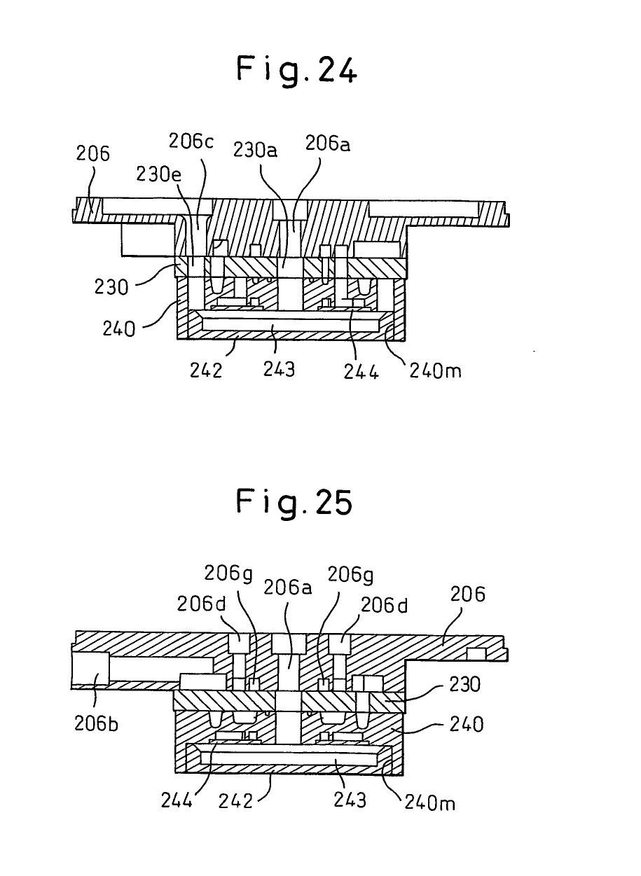

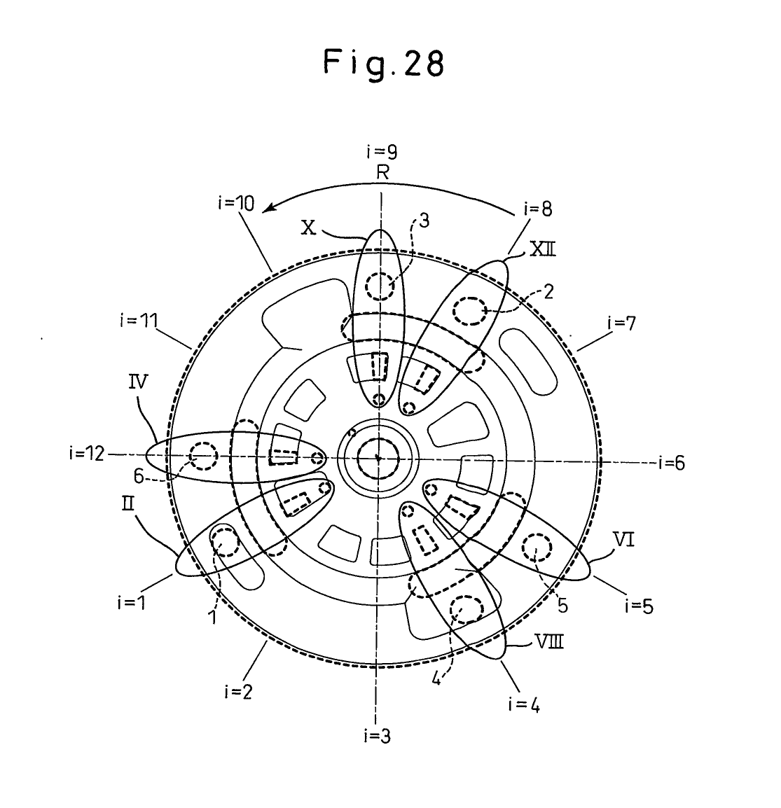

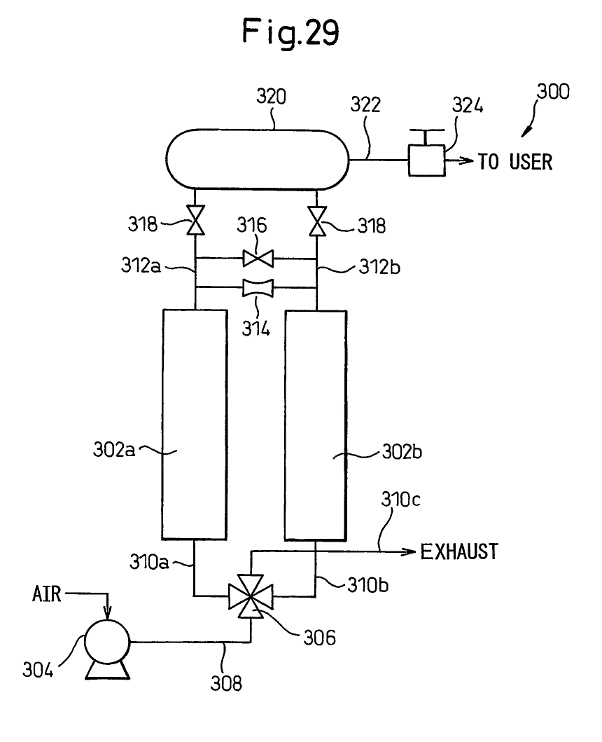

With reference to FIGS. 16-28, a second embodiment of the present invention will be described below.

The oxygen concentrator 200 according to the second embodiment includes a plurality of adsorption cylinders 202 which are arranged parallel to each other and filled with an adsorbent, for example, zeolite which selectively adsorbs nitrogen gas more than oxygen gas, upper and lower headers 204 and 206 holding the adsorption cylinders 202 therebetween, a rotary valve 220 and drive mechanism, comprising a motor 208 and gear box 210, for rotating the rotary valve 220, a spring 212 for biasing a cover of the rotary valve 220 and a bearing 214, between the spring 212 and the rotary valve 220, which allows the rotary valve 220 to rotate.

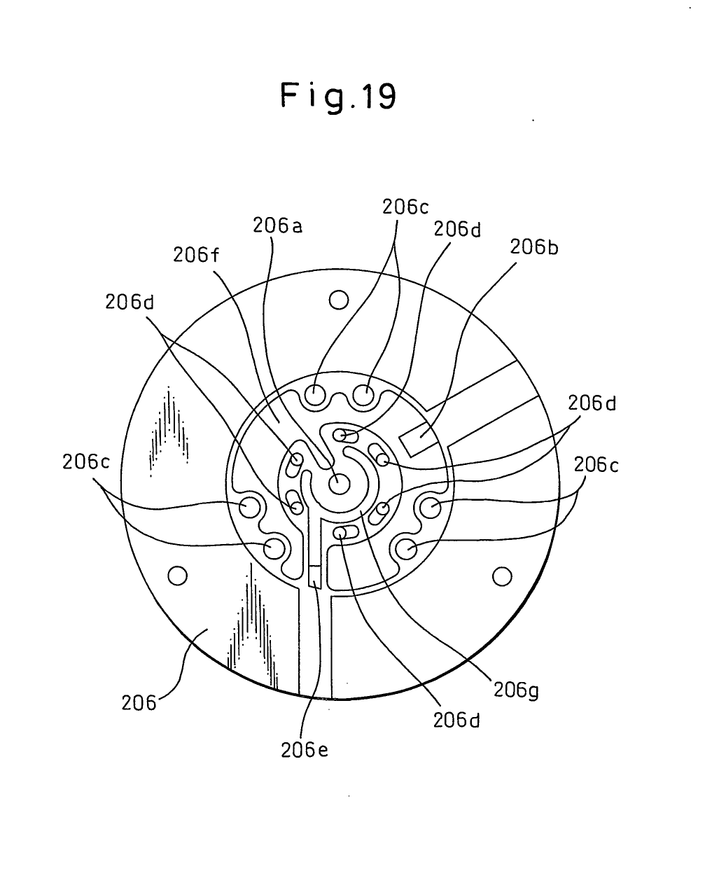

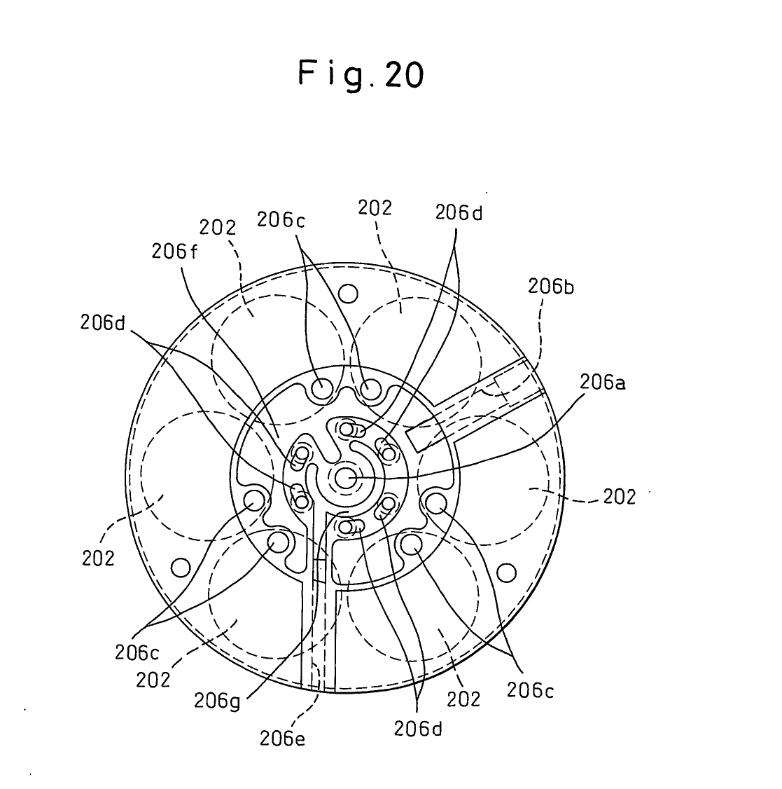

The oxygen concentrator 200 has six adsorption cylinders 202 each of which includes a top or first orifice (not shown) and a bottom or second orifice (not shown). The upper header 204 includes six passages 204a which are fluidly connected to the upper orifices of the adsorption cylinders 202. The lower header 206 includes a supply passage 206a which is fluidly connected to the compressor 12 (FIG. 1), an exhaust passage 206b which is fluidly connected to the vacuum pump 18 (FIG. 1) through the exhaust conduit 22 (FIG. 1), first passages 206c which are connected to the bottom orifices of the adsorption cylinders 202 and second passages 206d which are fluidly connected to the passages 204a of the upper header 204 through connection conduits 116. With reference to FIGS. 19 and 20, the lower header 206 further includes a C-shaped output groove 206g extending around the centrally disposed supply passage 206a, a output passage 206e which opens to the output groove 206g and is fluidly connected to the oxygen supply conduit 24 (FIG. 1) and an exhaust groove 206f, around the output groove 206g which fluidly communicates with the exhaust passage 206b.

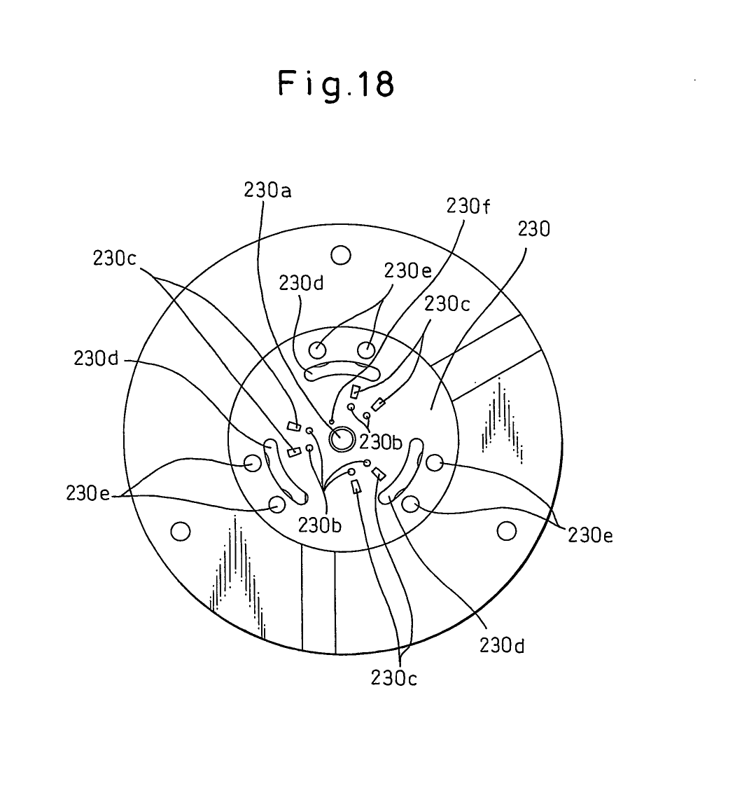

The rotary valve 220 includes a stator 230 comprising a circular plate member, stationarily attached to the lower header 206, and a rotor 240 comprising a circular plate member which is rotated by the motor 208 relative to the stator 230. With reference to FIGS. 18 and 20, the stator 230 includes a centrally disposed supply port 230a, six output ports 230b, six first ports 230c, three exhaust ports 230d, six second ports 230e and a sealing port 230f, which axially extend through the plate member of the rotor 240. The supply port 230a fluidly communicates with the supply passage 206a of the header 206. The output ports 230b fluidly communicate with the output passage 206e through the output groove 206g. The first ports 230c fluidly communicate with the second passages 206d of the lower header 206. The exhaust ports 230d fluidly communicate with the exhaust passage 206b through the exhaust groove 206f. The second ports 230e fluidly communicate with the first passages 206c of the lower header 206. The sealing port 230f fluidly communicates with the exhaust passage 206b through the exhaust groove 206f.

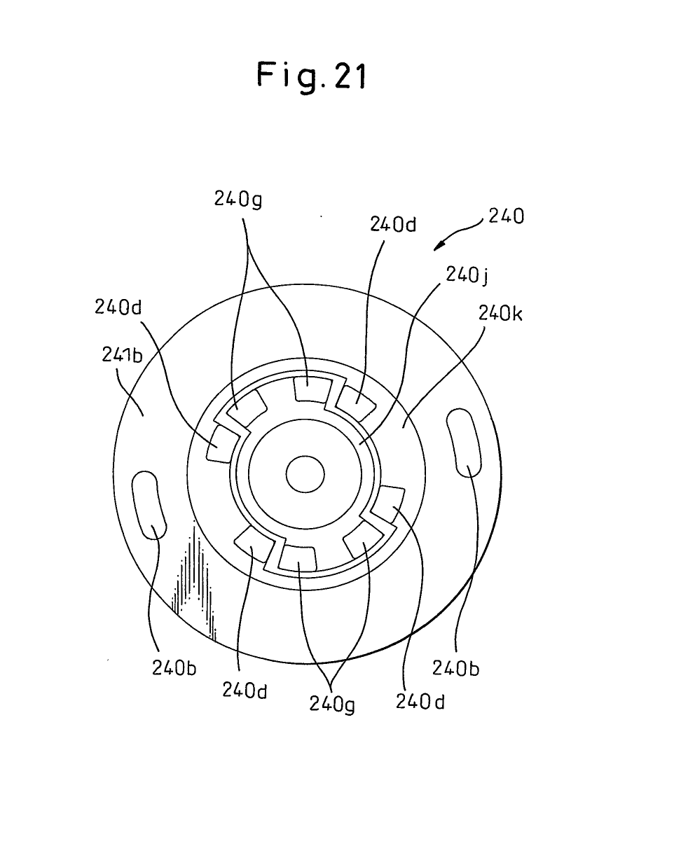

With reference to FIGS. 21-23, the rotor 240 has a front face 241a contacting the stator 130 and an opposite rear face 241b. On the front face 241a, the rotor 240 defines two first recesses 240c, two second recesses 240e which are fluidly connected to each other by a circular groove 240f and a circular sealing recess 240i. The circular groove 240f is disposed to fluidly communicate with the three exhaust ports 230d of the stator 230. On the rear face 241b, the rotor 240 defines a receptacle 240m for receiving a cover 242, an inner groove 240j and a outer groove 240k. A flow passage 243 is defined between the cover 242 disposed in the receptacle 240m and the rotor 240. The rotor 240 further includes a centrally disposed supply opening 240a, two first openings 240b, four second openings 240d and four third openings 240g, which axially extend through the rotor.

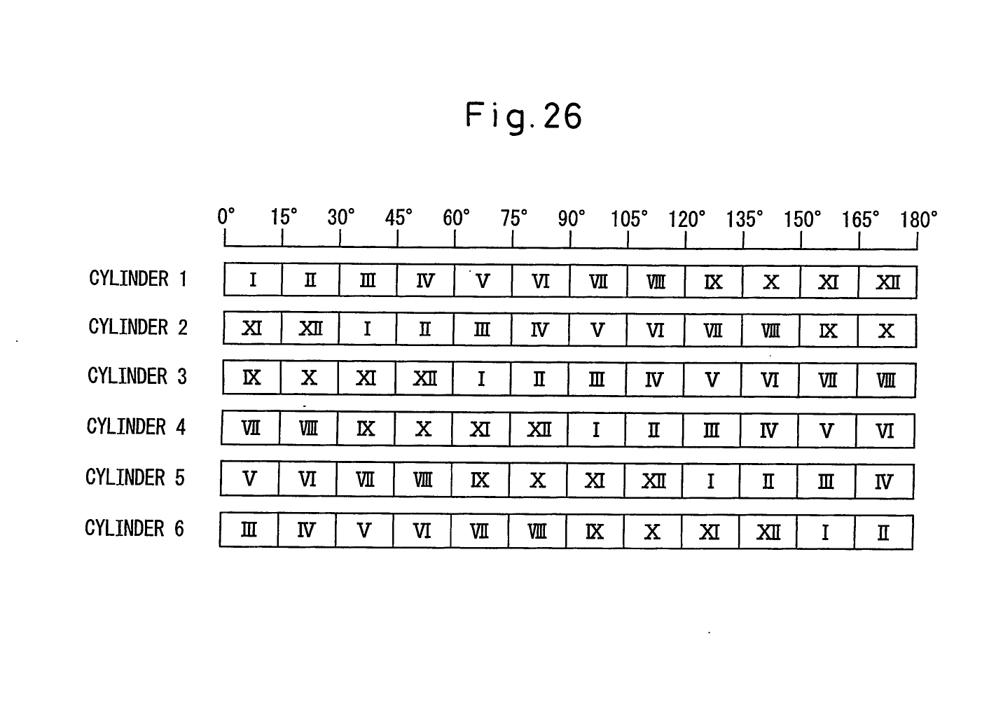

With reference to FIGS. 26-28, the operation of the oxygen concentrator 200 according the second embodiment will be described below. In the second embodiment, the oxygen concentrator 200 includes the six adsorption cylinders 102 the positions of which are indicated by reference numbers 1-6, in FIGS. 26-28. In the following description, the operation of the oxygen concentrator 200 will be described in relation to one of the adsorption cylinders, cylinder 1 which is disposed at position 1.

Step I (Pressurization Step)

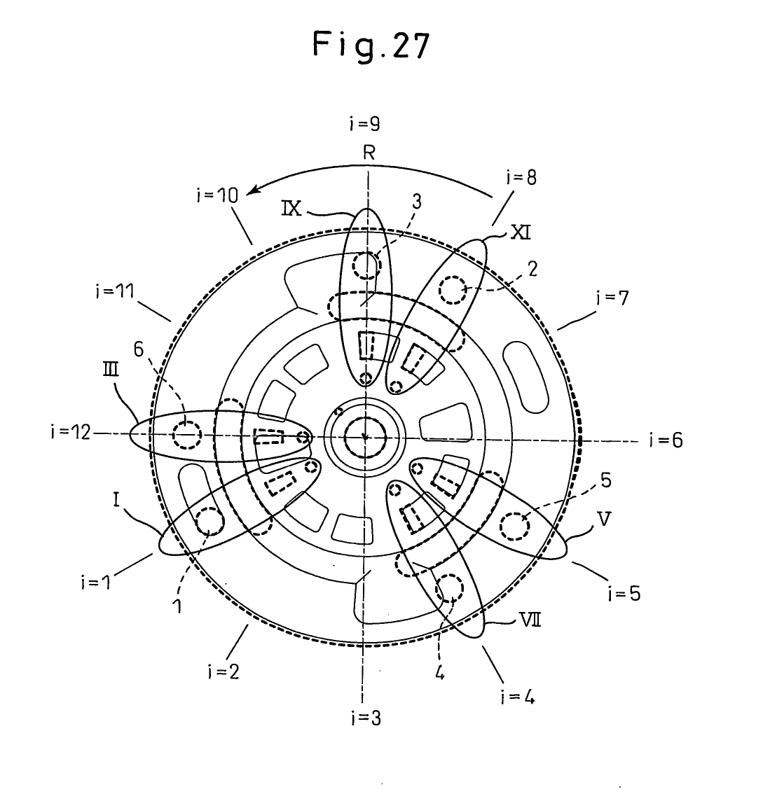

The rotor 240 is at the home position shown in FIG. 27 where the first opening 240b aligns with one of the second port 230e of the stator 230 so that the air is supplied to cylinder 1 from the compressor 12 through the air supply conduit 16, the supply passage 206a of the lower header 206, the supply port 230a of the stator 230a, the supply opening 240a of the rotor 240, the passage 243 defined between the stator 240 and the cover 242, the first opening 240b, the second port 230e and the lower orifice of cylinder 1.

Step II (Pressurization-Generation Step)

The rotator 240 rotates to a rotational position at 15 degrees from the home position where the first opening 240b is still aligned with the second port 230e and, therefore, the compressed air is supplied to cylinder 1. At the same time, the first recess 240c of the rotor 240 aligns with both the output port 230b and the first port 230c of the stator 230. This rotational position of the rotor 240 allows the oxygen enriched gas to flow from cylinder 1 to the user through the upper orifice of cylinder 1, the passage 204a of the upper header 204, the connection conduit 216, second passage 206d of the lower header 206, the first ports 230c of the stator 230, the first recess 240c of the rotor 240, the output ports 230b of the stator 230, the output groove 206g, the output passage 206e of the lower header 206 and the output conduit 24.

Step III (Generation Step)

The rotator 240 rotates to a rotational position at 30 degrees from the home position where the first opening 240b of the rotor 240 is not aligned with the second port, and therefore, the supply of the compressed to cylinder 1 is terminated. However, the first recesses 240c is still aligned with both the output ports 230b and the first ports 230c of the stator 230. Therefore, the oxygen enriched gas is still supplied to the user from cylinder 1 as described above.

Step IV (First Depressurization-Equalization Step)

The rotor 240 rotates to a rotational position at 45 degrees from the home position where the second opening 240d of the rotor 240 aligns with the first port 230c communicating with cylinder 1 and, at the same time, the third opening 240g align with the first port 230c communicating with cylinder 3. This rotational position of the rotor 240 allows the oxygen enriched gas to flow from cylinder 1 to cylinder 3 through the upper orifice of cylinder 1, the passage 204a of the upper header 204, the connection conduit 216, the second passages 206d of the lower header 206, the first port 230c of the stator 230, the second opening 240d, the outer groove 240k, the third opening 240g of the rotor 240, the first port 230c of the stator 230, the second passage 206d of the lower header 206, the connection conduit 216, the passage 204a of the upper header 204 and the upper orifice of cylinder 3. Thus, the pressure in cylinder 1 is reduced and the pressure in cylinder 3 is increased to equalize the pressure in cylinders 1 and 3.

Step V (Second Depressurization-Equalization Step)

The rotor 240 rotates to a rotational position at 60 degrees from the home position where the second opening 240d align with the first port 230c communicating with cylinder 1 and at the same time the third opening 240g align with the first port 230c communicating with cylinder 4. This rotational position of the rotor 240 allows the oxygen enriched gas to flow from cylinder 1 to cylinder 4

through the upper orifice of cylinder 1, the passage 204a of the upper header 204, the connection conduit 216, the second passages 206d of the lower header 206, the first port 230c of the stator 230, the second opening 240d, the outer groove 240k, the third opening 240g of the rotor 240, the first port 230c of the stator 230, the second passage 206d of the lower header 206, the connection conduit 216, the passage 204a of the upper header 204 and the upper orifice of cylinder 3. Thus, the pressure in cylinder 1 is reduced and the pressure in cylinder 4 is increased to equalize the pressure in cylinders 1 and 4.

Step VI (Third Depressurization-Equalization Step)

The rotor 240 rotates to a rotational position at 75 degrees from the home position where the second opening 240d align with the first port 230c communicating with cylinder 1 and at the same time the third opening 240g align with the first port 230c communicating with cylinder 5. This rotational position of the rotor 240 allows the oxygen enriched gas to flow from cylinder 1 to cylinder 5

through the upper orifice of cylinder 1, the passage 204a of the upper header 204, the connection conduit 216, the second passages 206d of the lower header 206, the first port 230c of the stator 230, the second opening 240d, the outer groove 240k, the third opening 240g of the rotor 240, the first port 230c of the stator 230, the second passage 206d of the lower header 206, the connection conduit 216, the passage 204a of the upper header 204 and the upper orifice of cylinder 3. Thus, the pressure in cylinder 1 is reduced and the pressure in cylinder 5 is increased to equalize the pressure in cylinders 1 and 5.

Step VII (Cocurrent Depressurization Step)

The rotor 240 rotates to a rotational position at 90 degrees from the home position where the third openings 240g of the stator 240 align with the first ports 230c communicating with cylinders 1 and 6. This rotational position of the rotor 240 allows the oxygen enriched gas to flow, as a purge gas, from cylinder 1 to cylinder 6 through the lower orifice of cylinder 1, through the upper orifice of cylinder 1, the passage 204a of the upper header 204, the connection conduit 216, the second passages 206d of the lower header 206, the first port 230c of the stator 230, the third opening 240g, the third opening 240h, the inner groove 240j, the third opening 240h, the third opening 240g of the stator 240, the first port 230c of the stator 230 of the stator 230, the second passages 206d of the lower header 206d, the connection conduit 216, the passage 204a of the upper header 204 and the upper orifice of cylinder 6. At that time, a purge step, which will be described below, is conducted in cylinder 6.

Step VIII (Evacuation Step)

The rotor 240 rotates to a rotational position at 105 degrees from the home position where the second port 230e of the stator 230 aligns with the second recess 240e. This rotational position of the rotor 240 allows the gas in cylinder 1 to be evacuated by the vacuum pump 22 through the lower orifice of cylinder 1, the first passage 206c of the lower header 206, the second port 230e of the stator 230, the second recess 240e, the circular groove 240f of the rotor 240, the exhaust ports 230d of the rotor 240, the exhaust groove 206f, the exhaust passage 206b of the lower header 206 and the exhaust conduit 22.

Step IX (Purge Step)

The rotor 240 rotates to a rotational position at 120 degrees from the home position where the second port 230e of the stator 230 still aligns with the second recess 240e and the third openings 240g of the stator 240 align with the first ports 230c communicating with cylinders 1 and 2. Therefore, the oxygen enriched gas is supplied to cylinder 1 from cylinder 2 as described in relation to Step VII while the gas in cylinder 1 is still evacuated as described above.

Step X (Third Pressurization-Equalization Step)

The rotor 240 rotates to a rotational position at 135 degrees from the home position where the third openings 240g align with the first ports 230c communicating with cylinders 1 and 3. This rotational position of the rotor 240 allows the oxygen enriched gas to flow from cylinder 3 to cylinder 1 as described above in relation to Step VI.

Step XI (Second Pressurization-Equalization Step)

The rotor 240 rotates to a rotational position at 150 degrees from the home position where the second openings 240d align with the first ports 230c communicating with cylinders 1 and 4. This rotational position of the rotor 240 allows the oxygen enriched gas to flow from cylinder 4 to cylinder 1 as described above in relation to Step V.

Step XII (First Pressurization-Equalization Step)

The rotor 240 rotates to a rotational position at 165 degrees from the home position where the second openings 240d align with the first ports 230c communicating with cylinders 1 and 5. This rotational position of the rotor 240 allows the oxygen enriched gas to flow from cylinder 5 to cylinder 1 as described above in relation to Step IV.

As shown in the drawings, in the second embodiment, the six output ports 230b, the six first ports 230c, the three exhaust ports 230d and the six second ports 230e are disposed along different circles about the rotational axis of the rotor 140. Further, each of the ports fluidly communicating with each of the adsorption cylinders 202 are disposed at any one of (i)th point, (m+i)th point, (2m+i)th point, (3m+i)th point, . . . , ((n−1)m+i)th point (i: integer=1 to m) along the circle. Here, i is integer i=1 to m, m is number of the adsorption cylinders and n is the number of cycle of the above described process during one rotation of the rotor, that is 2 in the second embodiment. This arrangement prevents the concentrator 200 from executing the same steps of the above described process at a rotational position of the rotor 240.

Further, according to the second embodiment of the present invention, the supply passage 206a, the exhaust passage 206b and the output passage 206e provide a common flow passages. The upper or first orifices of the adsorption cylinders 202 provide flow passages of a first subgroup of a selective flow passage group and the lower or second orifices of the adsorptions cylinders 202 provide flow passages of a second subgroup of the selective flow passage group.

1. An oxygen concentrating apparatus, for generating an oxygen enriched gas by adsorbing and removing nitrogen gas from air, comprising:
a plurality of adsorption cylinders which is filled with holding an adsorbent which selectively adsorbs nitrogen gas more than oxygen gas, the adsorption cylinders having first and second orifices;
a output conduit for directing the oxygen enriched gas to a user through the first orifice;
means for supplying compressed air to the adsorption cylinders through the second orifice;
means for evacuating nitrogen gas from the adsorption cylinders through the second orifice; and
valve means for allowing the oxygen concentrating apparatus sequentially in each of the adsorption cylinders:
(1) to pressurize one of the adsorption cylinders by directing the compressed air through the second orifice thereof;
(2) to remove the oxygen enriched gas from said one of the adsorption cylinders to the output conduit through the first orifice thereof,
(3) to direct the oxygen enriched gas as a purge gas from said one of the adsorption cylinders through the first orifice thereof into one of the other adsorption cylinders through the first orifice thereof, from which one of the other adsorption cylinders the internal gas is evacuated; and
(4) to evacuate the internal gas out of said one of the adsorption cylinders through the second thereof.

2. An oxygen concentrating apparatus, for generating an oxygen enriched gas by adsorbing and removing nitrogen gas from air, comprising:
a plurality of adsorption cylinders for holding an adsorbent which selectively adsorbs nitrogen gas more than oxygen gas, the adsorption cylinders having first and second orifices;
a output conduit for directing the oxygen enriched gas to a user through the first orifice;
means for supplying compressed air to the adsorption cylinders through the second orifice;
means for evacuating nitrogen gas from the adsorption cylinders through the second orifice; and
valve means for allowing the oxygen concentrating apparatus, sequentially in each of the adsorption cylinders:
(1) to pressurize one of the adsorption cylinders by directing the compressed air through the second orifice thereof;
(2) to remove the oxygen enriched gas from said one of the adsorption cylinders to the output conduit through the first orifice thereof,
(3) to reduce the pressure in said one of the adsorption cylinders by directing the oxygen enriched gas through the first orifice into one of the other adsorption cylinders through the first orifice thereof to increase the pressure in the one of the other adsorption cylinders; and
(4) to evacuate the internal gas out of said one of the adsorption cylinders through the second thereof.

3. An oxygen concentrating apparatus according to claim 1, wherein the first orifices of said one of the adsorption cylinders and one of the other adsorption cylinders are closed by said valve means when the oxygen enriched gas is directed from said one of the adsorption cylinders to said one of the other adsorption cylinders.

4. An oxygen concentrating apparatus according to claim 1, wherein said valve means comprises a rotary valve.

5. A method of generating an oxygen enriched gas by adsorbing and removing nitrogen gas from air with an oxygen concentrating apparatus having a plurality of adsorption cylinders for holding an adsorbent which selectively adsorbs nitrogen gas more than oxygen gas, a output conduit for directing the oxygen enriched gas to a user, means for supplying compressed air to the adsorption cylinders, and means for evacuating nitrogen gas from the adsorption cylinders, the method comprising the steps of:
(1) pressurizing one of the adsorption cylinders by directing the compressed air;
(2) removing the oxygen enriched gas from said one of the adsorption cylinders to the output conduit;
(3) reducing the pressure in said one of the adsorption cylinders by directing the oxygen enriched gas into one of the other adsorption cylinders to increase the pressure in the one of the other adsorption cylinders;
(4) evacuating the internal gas out of said one of the adsorption cylinders; and
(5) increasing the pressure in said one of the adsorption cylinders by directing the oxygen enriched gas into said one of the adsorption cylinders from one of the other adsorption cylinders in which the pressure is decreased in step (3).

6. A rotary valve, adapted to use in a flow system including a plurality of common flow passages and a selective flow passage group composed of a plurality of subgroups, each of the subgroups including the same number M of flow passages, for switching the fluid communications between at least one of the plurality of common flow passages and at least one of the flow passages of the selective flow passage group and/or between the flow passages of the subgroups, the rotary valve comprising:
a stator comprising a plate member including opposing front and rear sides, a plurality of ports which extend between the front and rear sides through the plate member and fluidly communicate with the common flow passages and the flow passages of the plurality of subgroups of the selective flow passage group;
a rotor rotatable about an axis relative to the stator, the rotor comprising a plate member including a front side contacting with the front side of the stator and an opposite rear side, the plate member of the rotor defining in its front side a plurality of openings each of which can fluidly communicate with each of the ports of the rotor, the plurality of openings of the stator being disposed symmetrically about the axis so that the configuration of the front side coincides with the configuration of the front side of the rotor when the rotor rotates by 1/n rotations (n: integer);
the ports of the stator, which fluidly communicate with the flow passages of the different subgroups of the selective flow passage group, being disposed along circles of different diameter about the axis;
each of the ports, fluidly communicating with the flow passage of one of the subgroups, is disposed at any one of (i)th point, (m+i)th point, (2m+i)th point, (3m+i)th point, . . . , ((n−1)m+i)th point (i: integer=1 to m) along the circle; and
the points which equally divide the circle into a plurality of (nm) segments.

7. A rotary valve according to claim 6, wherein the number n is selected so that there is no greatest common divisor between n and m more than 1.
